(19) United States
(12) Patent Application Publication
(10) Pub. No.: US 2013/0209640 A1
(43) Pub. Date: Aug. 15, 2013

(54) BAKING PAN FOR CUPPED FOOD PRODUCTS

(71) Applicant: Louis F. HENRY, New York, NY (US)

(72) Inventor: Louis F. HENRY, New York, NY (US)

(21) Appl. No.: 13/588,817

(22) Filed: Aug. 17, 2012

Related U.S. Application Data
(60) Provisional application No. 61/525,558, filed on Aug. 19, 2011.

(51) Int. Cl. A21B 3/13

(52) U.S. Cl. CPC A21B 3/13
USPC 426/505; 99/426

(57) ABSTRACT

The present disclosure provides a baking assembly with a first pan and a second pan. A food product is cooked between the two pans, and due to the shape of the two pans, has a cup shape than can be filled.

### CROSS-REFERENCE TO RELATED APPLICATIONS

The present application claims priority to U.S. Provisional Patent Application No. 61/525,558, filed on Aug. 19, 2011, which is herein incorporated by reference.

### BACKGROUND OF THE DISCLOSURE

1. Field of the Disclosure

The present disclosure relates to baking pans for food products. More particularly, the present disclosure relates to a two-piece baking pan that bakes food products into the shapes of cups with a hollow interior that can be filled after baking.

2. Description of the Related Art

There is a continuing need for more creative and useful ways to prepare food products. The present disclosure addresses this need.

### SUMMARY OF THE DISCLOSURE

The present disclosure provides a baking pan assembly comprising a first pan comprising one or more baking compartments formed in a surface thereof, and a second pan comprising one or more protrusions corresponding to each of said compartments. The second pan is on top of the first pan in the baking pan assembly, so that each of the protrusions is at least partially within a corresponding one of said compartments.

### BRIEF DESCRIPTION OF THE DRAWINGS

FIG. 1 is a top view of the bottom pan of the pan assembly of the present disclosure;

FIG. 1a is a side view of the bottom pan of FIG. 1;

FIG. 2 is a top view of the top pan of the pan assembly of the present disclosure;

FIG. 2a is a side view of the top pan of the pan assembly of the present disclosure;

FIG. 3 is a perspective view of the pan assembly of the present disclosure with the top pan placed over the bottom pan;

FIG. 4 is a perspective view of the pan assembly of the present disclosure, inverted and with the bottom pan removed, and with food products; and

FIG. 5 shows food products made with the pan assembly of the present disclosure.

### DETAILED DESCRIPTION OF THE DISCLOSURE

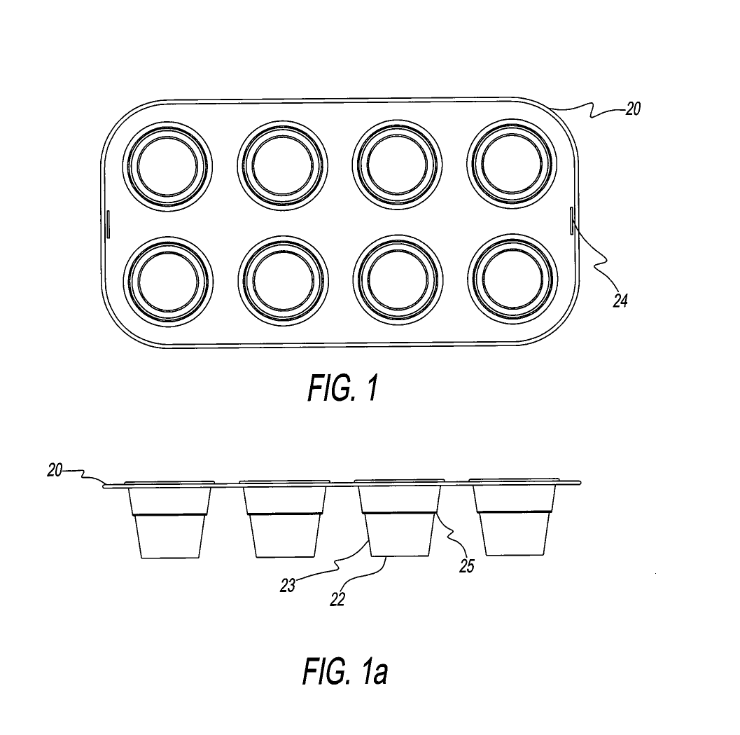

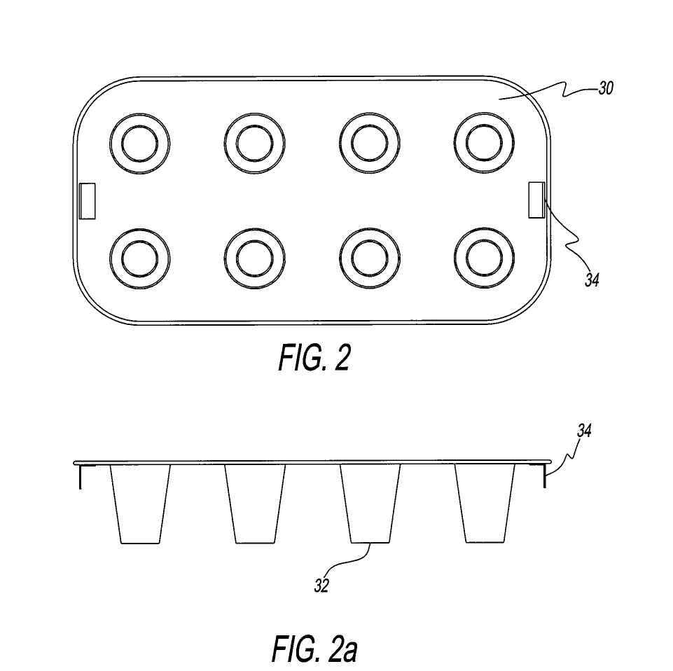

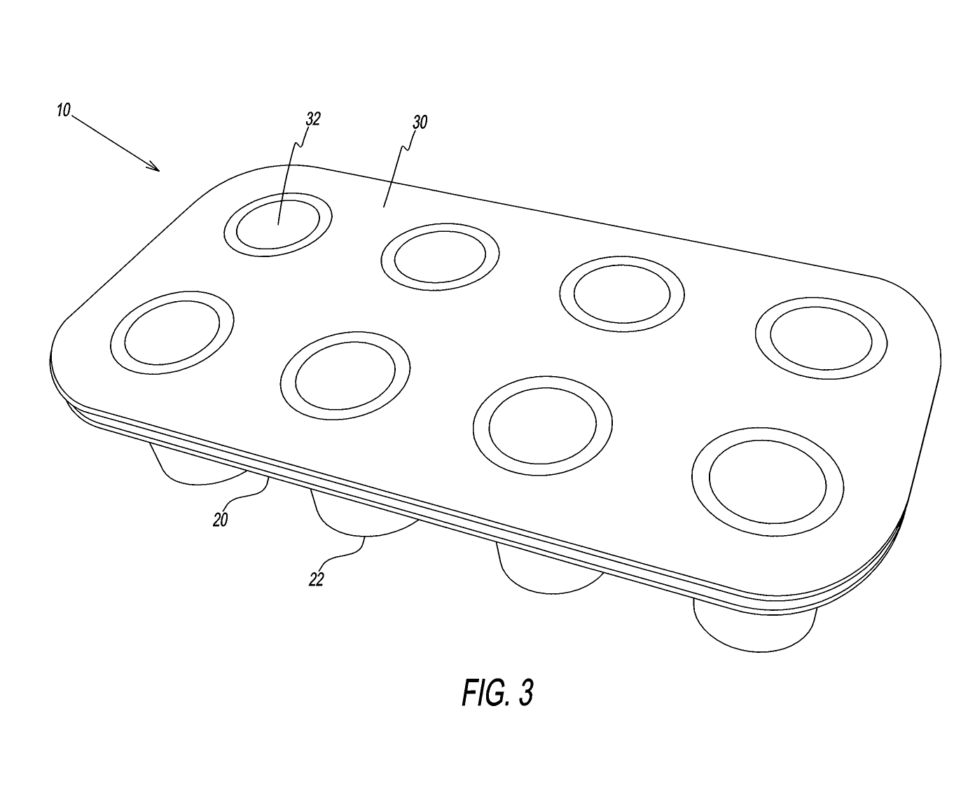

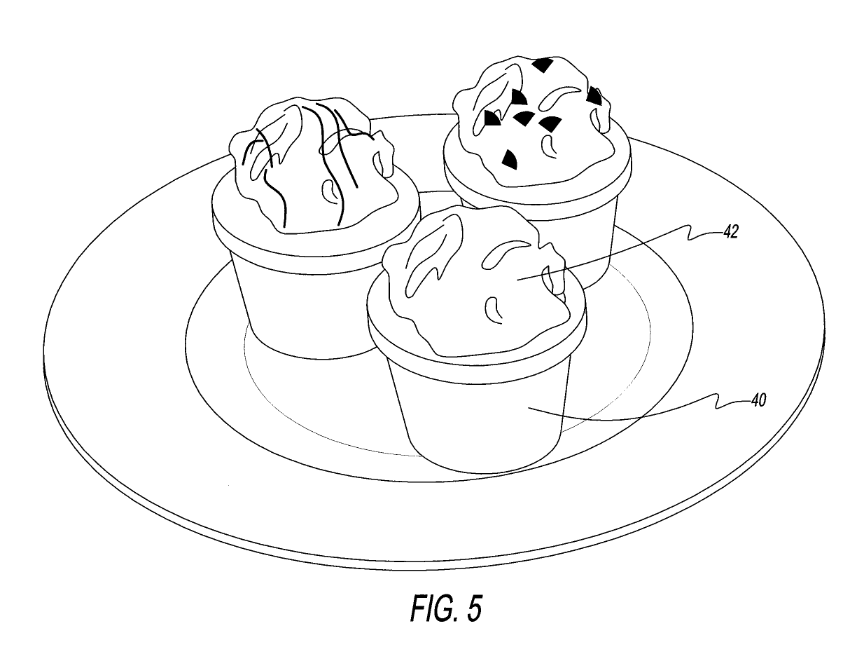

Referring to FIGS. 1-5, pan assembly 10 is shown, and has bottom pan 20 and top pan 30. Bottom pan 20 has one or more baking compartments 22 in a surface thereof. Compartments 22 are open-topped wells that have a depth, which can hold batter for a food product, as discussed below. Top pan 30 has one or more protrusions 32 that can have a shape generally conforming to those of compartments 22. Each of protrusions 32 will be smaller in diameter or width than the corresponding compartment 22. In the shown embodiment, compartments 22 and protrusions 32 are conical in shape, with a diameter that tapers off from a top end to a bottom end.

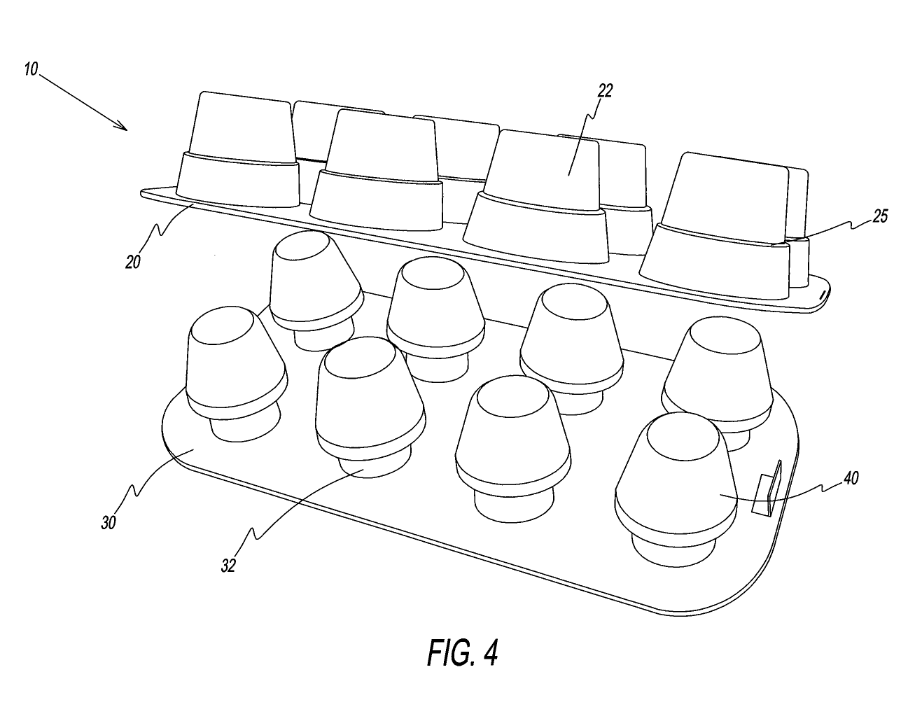

To make food products 40, the user pours batter or baking dough into compartments 22, and places top pan 30 over bottom pan 20 to form assembly 10, so that protrusions 32 are at least partially disposed within compartments 22. The batter or dough is cooked in the annular space formed between protrusions 32 and the walls 23 of compartments 22. When the baking is done, the user can invert assembly 10, and remove food products 40 from protrusions 32 (FIG. 4). Food products 40 have a hollow interior, and can be filled, if desired, with any type of filling 42, such as fruit, pudding, cream, or ice cream.

Thus, pan assembly 10 provides a very simple and easy to use way to make creative and customizable food products 40. There are only two components to assembly 10, and it is very easy to assemble, disassemble, and clean.

The materials used for bottom pan 20 and top pan 30 can be any suitable for contact with food products. These include, but are not limited to, aluminum (drawn/stamped, or cast), carbon steel, or silicone. Any of these materials can be coated with a non-stick coating. Each of top pan 30 and bottom pan 20 can also have rolled outer edges, as shown.

Top pan 30 can have a spacer 34 that ensures there will be a gap between top pan 30 and bottom pan 20 during baking. This in turn helps to ensure that there is the above-described annular space between walls 23 of compartments 22, and protrusions 32. The height of spacer 34 can vary, and in one embodiment can be about 0.75 inches. Bottom pan 20 can have a groove 24 to receive spacer 34 when assembly 10 is being used.

Each of compartments 22 can also have a ridge 25 formed in wall 23, where the diameter of compartment 22 changes abruptly. Ridge 25 can serve as a fill line, to which the user knows to fill compartment 22 with the batter or dough. It can also provide additional structural integrity for baked food product 40.

In the shown embodiment, there are eight compartments 22 and protrusions 32, in a four by two array. The present disclosure contemplates other numbers and arrangements of compartments and protrusions. In addition, compartments 22 and protrusions 32 are shown as having conical shapes. However, the present disclosure contemplates different shapes, such as cylindrical, square, rectangular, elliptical, triangular, or polygonal. Baking compartments 22 may also have different shapes to those of protrusions 32, and vice versa.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A baking pan assembly, comprising:
a first pan comprising one or more baking compartments formed in a surface thereof; and
a second pan comprising one or more protrusions corresponding to each of said compartments,
wherein said second pan is on top of said first pan in the baking pan assembly, so that each of said protrusions is at least partially within a corresponding one of said compartments.

2. The baking pan assembly of claim 1, wherein each of said protrusions and said corresponding one of said compartments form an annular space therebetween.

3. The baking pan assembly of claim 1, wherein said second pan has at least one spacer projecting from a bottom surface thereof, wherein said at least one spacer contacts said surface of said first pan, so that said first pan and said second pan are spaced apart in the baking pan assembly.

4. The baking pan assembly of claim 1, wherein said protrusions have a shape that generally conforms to a shape of said baking compartments.

5. The baking pan assembly of claim 1, wherein each of said protrusions and said compartments have conical shapes.

6. The baking pan assembly of claim 5, wherein said compartments have a ridge formed in an outer wall thereof.

7. A method of preparing a food product using the baking pan assembly of claim 1, the method comprising the steps of:
placing batter in at least one of said compartments;
placing said second pan over said first pan to form the baking pan assembly; and
cooking said batter within said baking pan assembly.
